(19) United States
(12) Patent Application Publication
(10) Pub. No.: US 2010/0167029 A1
(43) Pub. Date: Jul. 1, 2010

(54) Lyocell Web Product

(75) Inventor: MENGKUI LUO, AUBURN, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: WEYERHAEUSER COMPANY, FEDERAL WAY, WA (US)

(21) Appl. No.: 12/347,538

(22) Filed: Dec. 31, 2008

(51) Int. Cl. B32B 5/02; B32B 7/02

(52) U.S. Cl. 428/212; 428/332; 442/308; 442/189; 442/340

(57) ABSTRACT

A web comprising a layer of airlaid pulp or synthetic material overlaying and fastened to at least one layer of regenerated cellulose fiber. The airlaid fluff or synthetic material can be sandwiched between two regenerated cellulose fiber layers. The regenerated cellulose can be viscose or lyocell.

### CROSS-REFERENCE TO RELATED APPLICATION

Related patent application includes U.S. patent application Ser. No. ______, (Attorney Docket Number 26624), filed Dec. 31, 2008.

This application relates to regenerated cellulose nonwoven webs and articles made therefrom.

Lyocell is a regenerated cellulose material made by dissolving cellulose in a mixture of N-methylmorpholine-N-oxide (NMMO) and water and extruding the solution into a regenerating bath, usually water. Other solvents that may be used are other amine oxides, ionic liquids, mixtures of ionic liquids and water, and mixtures of ionic liquids and organic solvents. Lyocell is a generic term for a fiber composed of cellulose precipitated from organic solution in which no substitution of hydroxyl groups takes place and no chemical intermediates are formed. Several manufacturers presently produce lyocell fibers. For example, Lenzing, Ltd, presently manufacturers and sell Tencel® fibers.

Lyocell fibers are particularly suitable for use in nonwoven applications because of their characteristic soft feel, water absorption, microdiameter size, biodegradability and the ability of these fibers to be combined to form either bonded or spunlaced webs. Fibers made from pulp with high hemicelluloses content are particularly suited for this application because of the added interfiber bonding attributed to hemicelluloses.

Most lyocell fibers are produced from high quality wood pulps that have been extensively processed to remove non-cellulose components, especially hemicelluloses. These highly processed pulps are referred to as dissolving grade or high α (high alpha) pulps, in which the term α refers to the percentage of cellulose remaining after extraction with 17.5% caustic. Alpha cellulose can be determined by TAPPI 203. Thus a high α pulp contains a high percentage of cellulose, and a correspondingly low percentage of other components such as hemicelluloses. The process required to generate a high α pulp significantly adds to the cost of lyocell fibers and products manufactured from these fibers. Typically, the cellulose for these high α pulps comes from both hardwoods and softwoods; softwoods generally having longer fibers than hardwoods.

A lower cost alternative to high α dissolving grade pulps is a low α pulp having a higher percentage of hemicelluloses. These low α pulps will have, preferably, a low copper number, a low lignin content and a low transition metal content and a broad molecular weight distribution.

Pulps which meet these requirements for low α pulps have been made and are described in U.S. Pat. Nos. 6,979,113, 6,686,093 and 6,706,876, assigned to the assignee of the present application. While high alpha pulps are also suitable for use in the present application, low alpha pulps such as Peach® pulp, available from Weyerhaeuser Company, Federal Way, Wash., are suitable. These lower alpha pulps provide the benefit of lower cost and better bonding for nonwoven textile applications because of their high hemicelluloses content. Selected Peach® pulp properties are given in Table 1.

TABLE 1
Peach ® pulp properties

| | |
|---|---|
| S₁₈ % | 8-19 |
| % Xylan | 2-9 |
| % Mannan | 2-8 |
| % α cellulose | 80-91 |
| IV, dl/g | 2.5-4.5 |
| Cu no. g/100 g pulp | <1.0 |
| Mn, Fe, Cu, ppm each | <10 |
| Si ppm | <65 |
| Extractives % | <0.05 |

The term hemicelluloses refer to a heterogeneous group of low molecular weight carbohydrate polymers that are associated with cellulose in wood. Hemicelluloses are amorphous branched polymers, in contrast to cellulose which is a linear polymer. The principal simple sugars that combine to form hemicelluloses are: D-glucose, D-xylose, D-mannose, L-arabinose, D-galactose, D-glucuronic acid and D-galaturonic acid.

In one embodiment the lyocell fibers are made from a pulp with greater than about three percent by weight hemicelluloses. In another embodiment the fibers are made from a pulp with greater than about eight percent by weight hemicelluloses. In yet another embodiment the fibers are made from a pulp with greater than about twelve percent by weight hemicelluloses.

In one embodiment the lyocell fibers contain from about 4 to about 18% by weight hemicelluloses as defined by the sum of the xylan and mannan content of the fibers. In another embodiment the lyocell fibers contain from about 5 to about 10% by weight hemicelluloses and in yet another embodiment the fibers contain from about 9% to about 12% by weight hemicelluloses.

Lyocell fibers can be spun by various processes. Any of the following four processes may be used to make nonwoven fabrics of the present application.

In one embodiment the lyocell fiber is spun by the “spunbonding” process. The process is similar to meltblowing. In “spunbonding” the fiber is extruded into a tube with controlled air temperature and humidity and stretched by an air flow through the tube caused by a vacuum at the distal end or the fiber is extruded into a coagulation bath and stretched by flowing water. In general, spunbonded synthetic fibers are longer then meltblown synthetic fibers which usually come in discrete shorter lengths. In the present application the fibers are continuous.

In another embodiment the lyocell fiber is spun by a “centrifugal spinning” process. The “centrifugal spinning” process differs from meltblowing in that the polymer is expelled from apertures in the sidewalls of a rapidly spinning drum. The fibers are stretched somewhat by air resistance as the drum rotates. However, there is not usually a strong air stream present as in meltblowing.

In another embodiment the fiber is spun by a dry jet wet process. In this process the filaments exiting the spinneret orifices pass through an air gap before being submerged and coagulated in a liquid bath where the fiber is stretched mechanically.

In another embodiment the lyocell fiber is spun by the “meltblown” process. Where the term meltblown is used it will be understood that it refers to a process that is similar or analogous to the process used for the production of thermoplastic fibers, even though the cellulose is in solution and the spinning temperature is only moderately elevated. Fibers formed by the meltblown process can be continuous or discontinuous depending on the air velocity, air pressure, air temperature, viscosity of the solution, D.P. of the cellulose and combinations of these variables. In the continuous process the fibers are taken up by a collecting belt or reel and optionally stretched. In one embodiment for making a nonwoven meltblown lyocell fiber web the fibers are contacted with a non solvent such as water (or water NMMO mixture) by spraying, subsequently taken up on a moving foraminous support, washed and dried. The fibers formed by this method can be in a bonded nonwoven web or film depending on the extent of coagulation, calendaring or embossing or spunlaced. Spunlacing involves impingement with a water jet.

The present invention provides composite products comprising a layer of airlaid pulp or synthetic material overlaying and fastened to at least one layer of regenerated cellulose fiber. The airlaid fluff or synthetic material can be sandwiched between two regenerated cellulose fiber layers. The regenerated cellulose can be viscose or lyocell. The regenerated cellulose can be woven or nonwoven.

The present invention provides a diaper construction that has comparable acquisition times and rewets with a lower basis weight material.

The present invention provides composite products of nonwoven meltblown lyocell fiber webs that have a wide range of fiber diameters. The nonwoven webs comprise meltblown lyocell fibers of continuous length. In one embodiment the meltblown lyocell fibers in the web have a fiber diameter of from 1 to 30 microns. In another embodiment the meltblown lyocell fibers in the web have a fiber diameter of from 6 to 9 microns. The fiber diameters can range anywhere within 1 to 30 microns.

The basis weight of the individual nonwoven meltblown lyocell fiber webs in the composite product can range from about 5 g/m² to about 300 g/m². Other embodiments are from about 15 g/m² to about 125 g/m², from about 20 g/m² to about 75 g/m² and from about 25 g/m² to about 40 g/m². Combinations of different basis weights of the nonwoven meltblown lyocell fiber webs can be used.

The single layer nonwoven lyocell fiber webs suitable for composite products can be made from dried or never-dried webs. In the method a never-dried web is combined with a layer of synthetic material or airlaid wood pulp fiber and embossed or thermobonded or spunlaced either from one side or from both sides and then dried. Alternatively the web can be dried, combined with a layer of synthetic material or airlaid wood pulp fiber and embossed or thermobonded or spunlaced (with water or steam).

Never-dried multilayer nonwoven meltblown lyocell fiber webs are also suitable for manufacture of composite products of the present application. For example, a never-dried nonwoven meltblown lyocell fiber web is laid down on a support and a layer of synthetic material or airlaid wood pulp fiber is laid down over the first, then another never dried nonwoven meltblown lyocell fiber web is laid on top of the layer of synthetic material or pulp, sandwiching the synthetic material or pulp layer between the two lyocell layers. The combined web structure is then embossed or thermobonded or spunlaced either from one or both sides. The resulting web is then dried. Alternatively the never-dried nonwoven meltblown lyocell fiber web can be dried, combined with a layer of synthetic material or airlaid wood pulp fiber and another nonwoven meltblown lyocell fiber web is laid on top of the layer of synthetic material or pulp, sandwiching the synthetic material or pulp layer between the two lyocell layers. The combined structure is then embossed or thermobonded or spunlaced from one or both sides, and then dried.

Multilayer of synthetic layers or airlaid pulp layers can be used too at the same time. Woven or knitted cellulose fabrics from spinning staple fiber (viscose, lyocell, fiber from cellulose ionic liquids solution) into yarns can be used too.

Regenerated cellulose fibers such as lyocell and viscose are hygroscopic.

The pulp for the airlaid pulp can be any kraft or sulfite pulp from either hardwoods or softwoods. One pulp that can be used is Peach® pulp from Weyerhaeuser Company. Other pulps that can be used are kraft or sulfite pulps from either hardwoods or softwoods. Bicomponent synthetic fibers can be blended with pulp fibers too to enhance thermobonding or embossing.

The synthetic material may be polypropylene (PP), polyethylene (PE), PET or combinations of these. It may be spunbonded, meltblown or a film or electrospinning.

The basis weight for the nonwoven pulp layer can be 20 to 300 gsm. The basis weight for the polypropylene layer can be 5 to 200 gsm

In one embodiment the machine direction (MD) tensile strength of the composite is from about 200 to about 800 N/m, and in another embodiment it is from about 200 to about 2000 N/m. In one embodiment the machine direction elongation is from about 3 to about 50%. In another embodiment the machine direction elongation is from about 5 to about 15%, in another it is from about 5 to about 10 and in yet another embodiment it is from 7 to 9%. In yet another embodiment the machine direction modulus of the composite is from about 0.005 to 1.0 GPa.

In one embodiment the air flow permeability is from about 100 to about 7500 l/m²/sec. In another embodiment the air flow permeability is from about 800 to about 3500 l/m².

The dual layer material has different attributes depending upon whether the polypropylene or pulp layer is outwardly toward incoming material or inwardly away from incoming material. In an absorbent product there will be a difference if the polypropylene or pulp layer faces toward the incoming insult, touch or wipe or away from the incoming insult, touch, or wipe, depending on the use.

Both the kinetic and static coefficient of friction will change depending on which side of the dual layer material is facing toward the incoming material. Composite web showed large wet COF difference depending on the side being measured because the pulp or PP side is smoother than lyocell side. The use of a gauze pattern increased the difference on wet COF. Thus a composite with two different COF can be produced. In one embodiment, the wet COF is from 0.2 to 2. In another embodiment, the dry COF is 0.05 to 0.5.

The ratio of the kinetic wet coefficient of friction for the pulp in a pulp/lyocell combination will be from 0.2 to 1 times the lyocell coefficient of friction. The ratio of the static wet coefficient of friction for the pulp in a pulp lyocell combination will be 0.2 to 1.0 times the lyocell coefficient of friction.

The ratio of the kinetic dry coefficient of friction for the pulp in a pulp/lyocell combination will be 0.5 to 1 times the lyocell coefficient of friction. The ratio of the static dry coefficient of friction for the pulp in a pulp/lyocell combination will be 0.5 to 1 times the lyocell coefficient of friction.

The ratio of the kinetic wet coefficient of friction for the polypropylene in a polypropylene/lyocell combination will be from 0.2 to 1.0 times the lyocell coefficient of friction. The ratio of the static wet coefficient of friction for the polypropylene in a polypropylene/lyocell combination will be from 0.2 to 1.0 times the lyocell coefficient of friction.

The ratio of the kinetic dry coefficient of friction for the polypropylene in a polypropylene/lyocell combination will be 0.5 to 1.5 times the lyocell coefficient of friction. The ratio of the static dry coefficient of friction for the polypropylene in a polypropylene/lyocell combination will be 0.5 to 1.5 times the lyocell coefficient of friction.

Single Layer Nonwoven Meltblown Lyocell Fiber Webs

Peach® pulp, available from Weyerhaeuser Company, Federal Way, Wash. was dissolved in NMMO to prepare solutions of 8 to 15 percent by weight level of cellulose in NMMO.

Meltblown spinning was conducted with a Schwarz type 12.7 cm multirow nozzle (20 holes/cm) to produce meltblown lyocell nonwoven. Water was sprayed on the dope strands between the nozzle and the conveyor belt and the fibers collected on a moving conveyor belt. The deposited web was washed again by spraying water using several beams of spray nozzles. After the last washing the web was passed through a squeeze roll to remove water to a solid content of about 9 percent and then collected on a winder. The collected web, in the wet state, was optionally spunlaced and dried by the screen belt drier method or the screen drum method or through air drying. Spunlacing was performed on Aqua Jet equipment from the Fleissner Company, Germany. The unit was equipped with one drum with three beams, each beam having 16 nozzles/cm (40 nozzles/inch) and each nozzle having a diameter of 120μ. The water pressure was 3 bars and the initial water temperature was about 20° C. which increased with running to 30° C. to 40° C. The vacuum was 0.8 bars and the unit was run at a speed of 20 meters/min. Drying was conducted on through air drying. The hemicellulose content of the fiber in the web ranged from 8.7 percent to 10.1 percent by weight of the fiber, (xylan ranged from 4.5 to 5.3% and mannan from 4.2 to 4.8.

The formed nonwoven was wound up in the dry or wet state. In a second round of spunlacing operation, some meltblown lyocell nonwoven was selected to combine with commercial spunbond polypropylene nonwoven (PP) or airlaid cellulose to form composites (tables 2 and 3). This was done by placing the PP or airlaid pulp on top of meltblown lyocell nonwoven at the start of the spunlacing line for further bonding. Spunlacing and drying of the composites were carried out at the NC State, USA, using one to five beams and on either one or both sides using the Aqua Jet from Fleissner. After spunlacing the wet nonwoven web was through air dried. Spunlacing and drying were continuous.

TABLE 2
Nonwoven Forming Conditions

| | Web collection | | Fiber diameter |
|---|---|---|---|
| Sample | Meters/minute | Washing | Microns |
| 4-1 | 2.2 | water | 5.0 |
| 4-7 | 4.5 | water | 5.0 |

Meltblown lyocell samples were made with a Schwarz type nozzle with the following condition: Nozzle: 50 hole/inch nozzle, 5 inch length, throughput at 1.0 g dope/hole/minute for 10% dope at 105° C., meltblown air flow up to 450 m³/hour at 138° C. was used.

TABLE 3
Spunlacing and through air Drying (106° C.)

| | Line | Squeeze roll | Spunlace condition: | | | | |
|---|---|---|---|---|---|---|---|
| | speed | (spunlace) | beam Pressure (psi) | | | | |
| Sample | m/m | psi | 1 | 2 | 3 | 4 | 5 |
| 4-1-NO | 20 | 0 | 0 | 0 | 0 | 0 | 0 |
| 4-1-HE | 20 | 20 | 30 | 60 | 90 | 0 | 0 |
| 4-7-HE-G | 20 | 70 | 30 | 60 | 90 | 60 | 90 |
| 4-7-HH | 20 | 70 | 30 | 60 | 90 | 60 | 90 |
| 4-7-HE-P | 20 | 70 | 30 | 60 | 90 | 60 | 90 |
| 4-7-HE-PP | 20 | 70 | 30 | 60 | 90 | 60 | 90 |
| 4-7-HE-G-P | 20 | 70 | 30 | 60 | 90 | 60 | 90 |
| 4-7-HE-G-PP | 20 | 70 | 30 | 60 | 90 | 60 | 90 |

Meltblown lyocell nonwoven samples 4-1 and 4-7 were used for making composites with different layer combinations. G represents Gauze pattern of the composite obtained by changing the fabrics pattern of the drum for spunlacing. PP is a polypropylene spunbond with basis weight (BW) of 19 grams/m² (gsm). P is an airlaid nonwoven made from Weyerhaeuser Peach® pulp with basis weight of 45 gsm. NO means “No spunlacing”. HE means “Spunlacing on both sides”. HE means “one side spunlacing”. All the composites were through air dried at 106° C. with a line speed at 20 meters/minute (m/m). The composites were tested for strength and other properties (tables 4 and 5)

TABLE 4
Nonwoven Lyocell Web Properties

| | | | | Tensile | Tensile | Modulus of |
|---|---|---|---|---|---|---|
| | Air Permeability | | Tensile | Elongation | TEA | Elasticity |
| Sample | (ft3/min/ft2) | | (kN/m) | (%) | (J/m²) | (GPa) |
| 4-7-HE | 821.0 | MD | 0.46 | 2.7 | 28.8 | 0.1765 |
| | | CD | 0.02 | 109.5 | 18.7 | 0.0002 |
| 4-7-HE-PP | 535.3 | MD | 1.42 | 9.5 | 150.8 | 0.3099 |
| | | CD | 0.17 | 51.6 | 95.4 | 0.0058 |
| 4-7-HE-P | 159.3 | MD | 0.97 | 4.8 | 83.3 | 0.1859 |
| | | CD | 0.46 | 27.4 | 119.2 | 0.0372 |
| 4-7-HE-G | 653.9 | MD | 1.13 | 5.0 | 86.3 | 0.4151 |
| | | CD | 0.10 | 80.8 | 67.7 | 0.0011 |
| 4-7-HE-G-PP | 518.8 | MD | 1.48 | 9.6 | 168.2 | 0.2453 |
| | | CD | 0.17 | 64.4 | 106.8 | 0.0035 |
| 4-7-HE-P | 197.3 | MD | 1.19 | 6.1 | 136.8 | 0.1380 |
| | | CD | 0.33 | 25.4 | 78.8 | 0.0107 |
| HE-P | 242.5 | MD | 0.46 | 9.0 | 54.0 | 0.0762 |
| | | CD | 0.32 | 25.7 | 71.4 | 0.0172 |
| HE-PP | 931.3 | MD | 1.02 | 10.2 | 94.1 | 0.2423 |
| | | CD | 0.10 | 43.6 | 44.7 | 0.0038 |
| 4-7-HE-G | | MD | 0.94 | 5.73 | 83.06 | 0.081 |
| | | CD | 0.27 | 26.79 | 57.28 | 0.007 |

Air permeability was tested with ASTM D737-96. Tensile properties were measured with TAPPI method T-494.

TABLE 5
Multilayer composite properties (COF)

| | Basis | | Wet COF | | | | | |
|---|---|---|---|---|---|---|---|---|
| | weight | Caliper | Kinetic | | | Static | | |
| Sample | gsm | mm | top | bottom | Ratio* | top | bottom | Ratio* |
| 4-1-NO | 77 | | 0.978 | 1.018 | 1.0 | 0.888 | 0.890 | 1.0 |
| 4-1-HE | 67 | | 0.99 | 1.32 | 1.3 | 0.831 | 1.145 | 1.4 |
| 4-7-HH | 28 | 0.159 | 0.659 | 0.823 | 1.2 | 0.723 | 0.808 | 1.1 |
| 4-7- | 26 | 0.143 | 0.605 | 0.97 | 1.6 | 0.644 | 0.898 | 1.4 |
| HE-G | | | | | | | | |
| | | | | lyocell | | Pulp | lyocell | |
| | | | Pulp side | side | | side | side | |
| 4-7- | 65 | 0.249 | 0.398 | 0.68 | 1.7 | 0.405 | 0.616 | 1.5 |
| HE-P | | | | | | | | |
| 4-7- | 70 | 0.298 | 0.423 | 0.809 | 1.9 | 0.423 | 0.721 | 1.7 |
| HE-G-P | | | | | | | | |
| | | | | lyocell | | | lyocell | |
| | | | PP side | side | | PP side | side | |
| 4-7- | 33 | 0.144 | 0.397 | 0.787 | 2.0 | 0.435 | 0.839 | 1.9 |
| HE-PP | | | | | | | | |
| | Basis | | Dry COF | | | | | |
| | weight | Caliper | Kinetic | | | Static | | |
| Sample | gsm | mm | top | bottom | ratio | top | bottom | ratio |
| 4-1-NO | 77 | | 1.7 | | | 1.8 | | |
| 4-1-HE | 67 | | 0.201 | | | 0.232 | | |
| 4-7-HH | 28 | 0.159 | 0.167 | 0.173 | 1.036 | 0.138 | 0.141 | 1.022 |
| 4-7- | 26 | 0.143 | 0.141 | 0.162 | 1.149 | 0.121 | 0.124 | 1.025 |
| HE-G | | | | | | | | |
| | | | | lyocell | | Pulp | lyocell | |
| | | | Pulp side | side | | side | side | |
| 4-7- | 65 | 0.249 | 0.1373 | 0.1385 | 1.009 | 0.1581 | 0.1714 | 1.084 |
| HE-P | | | | | | | | |
| 4-7- | 70 | 0.298 | 0.1308 | 0.1406 | 1.075 | 0.1684 | 0.1714 | 1.018 |
| HE-G-P | | | | | | | | |
| | | | | lyocell | | | lyocell | |
| | | | PP side | side | | PP side | side | |
| 4-7- | 33 | 0.144 | 0.222 | 0.2 | 0.901 | 0.178 | 0.159 | 0.893 |
| HE-PP | | | | | | | | |

*Ratio is defined as COF of lyocell side with high COF divided by low COF lyocell side or COF of non-lyocell side.

Coefficient of friction (COF) was tested using TAPPI method T-549 to test wet and dry web composite at both sides: lyocell nonwoven sides or Pulp or PP side. For wet samples, the following modification was made
1. Samples were soaked in DI water for 20 seconds.
2. Then the wet sample was drained for 2 minutes.
3. Then the wet samples were placed between two paper towels and pressed for 2 minutes with the weight of 500 gram before testing.

For lyocell nonwoven web, there is low wet COF difference from both sides without spunlacing. But, there will be more COF difference after spunlacing and even more difference after gauze pattern for wet testing. Dry webs had similar COF from both sides (with or without gauze pattern).

Composite web showed large wet COF difference from both sides, and pulp or PP side is smooth than lyocell side. Gauze pattern increased the difference on COF (for wet). Thus a composite with two different COF can be produced.

Fiber tensile strength and elongation properties of the samples were carried out based on the nonwoven test methods of EDANA 20.2-89 or TAPPI method T-494.

In one embodiment the machine direction tensile strength is from about 200 to about 800 N/m, in and in another embodiment it is from about 200 to about 2000 N/m. In one embodiment the machine direction elongation is from about 3 to about 50%. In another embodiment the machine direction elongation is from about 5 to about 15%, in another it is from about 5 to about 10 and in yet another embodiment it is from 7 to 9%.

Gurley Stiffness was measured by TAPPI T543. Basis weight, caliper, density and bulk were measured by TAPPI T-220; air permeability was measured by TexTest FX 3300 which is based on ASTM D737.

In one embodiment the air flow permeability is from about 100 to about 7500 l/m²/sec. In another embodiment the air flow permeability is from about 800 to about 3500 l/m².

Fiber diameters were determined with a light optical microscope. One hundred fibers or fibers/bundles were counted for each sample to obtain the average diameter. Fiber bundles represent two or more coalesced fibers.

Meltblown lyocell nonwoven composite with PP or airlaid pulp was also used to substitute diaper component (ADL layer) for diaper testing (Tables 6-7). Weyerhaeuser rewet test measures the liquid acquisition times and rewets for three liquid doses under no load condition. Dosing is done into a dosing ring positioned 2.5 cm front of center. Rewet is measured with a 8.9 cm diameter weight (7 kpa/1 psi) for 2 minutes after each dosing with 11 cm diameter filter paper. Dosage is 100 ml 0.9% saline solution with food coloring. The wicking distance from the point of insult was measured after the 20 minute waiting time after each dose before the rewet was measured. Wicking does not occur as a straight edge sway from the point of insult so the distance was measured as the best average of each edge from the front to back of the diaper.

The commercial diaper (A) used for this test is constructed as follows (from top): nonwoven topsheet, nonwoven acquisition (ADL) (17 cm×6 cm) at 84 g/m2 basis weight, nonwoven, absorbent core (8.3 gram SAP and 11.2 gram of fluff), nonwoven, polymer nonwoven laminated backsheet. The diaper was slit lengthwise along the edge of the nonwoven topsheet to remove the nonwoven acquisition layer. A hairdryer was needed to help break the adhesive bonding between acquisition layer and the nonwoven topsheet. The various lyocell nonwoven composite with curly fiber layers were cut to the same size as the diaper A acquisition layer (17 cm×6 cm) and then inserted into the diaper A surrounds. The diaper A used as a control also had the acquisition layer removed and reinserted to simulate the process used for the lyocell nonwoven samples.

TABLE 6
Modified lyocell nonwoven for diaper testing

| | ADL layer properties | | | |
|---|---|---|---|---|
| Sample | BW total | Caliper | Weight | Density |
| Comparative 1 | | | | |
| Diaper A as is | 91 | 1.64 | 0.93 | 0.056 |
| Diaper A reconstructed | 91 | 1.64 | 0.93 | 0.056 |
| Comparative 2 | | | | |
| Diaper A substituted with 4-1-HH | 70 | | | |
| Present invention | | | | |
| Diaper A substituted with 4-7-HE-G-P (P side up) | 68 | | | |
| Diaper A substituted with 4-7-HE-G-P | 68 | | | |
| (P side down) | | | | |
| Diaper A substituted with 4-7-HE-G-PP | 35 | | | |
| (PP side up) | | | | |
| Diaper A substituted with 4-7-HE-G-PP | 35 | | | |
| (PP side down) | | | | |
| Diaper A substituted with 4-7-HE-P (P side up) | 68 | | | |
| Diaper A substituted with 4-7-HE-P | 68 | | | |
| (P side down) | | | | |
| Diaper A substituted with 4-7-HE-PP (PP side up) | 35 | | | |
| Diaper A substituted with 4-7-HE-PP | 35 | | | |
| (PP side down) | | | | |

| | Core properties | | | | | | | | | |
|---|---|---|---|---|---|---|---|---|---|---|
| | Acquisition | | | rewet | | | | wicking distance | | |
| | time seconds | | | grams | | | total | cm | | |
| | doses | | | doses | | | rewet | doses | | |
| Sample | 1 | 2 | 3 | 1 | 2 | 3 | grams | 1 | 2 | 3 |
| Comparative 1 | | | | | | | | | | |
| Diaper A as is | 30 | 25 | 31 | 0.1 | 2.1 | 25.5 | 27.8 | 20.7 | 26.2 | 31.6 |
| Diaper A reconstructed | 27 | 25 | 34 | 0.2 | 1.9 | 23 | 25.1 | 18.5 | 26 | 31.4 |
| Comparative 2 | | | | | | | | | | |
| Diaper A substituted | 55 | 54 | 63 | 0.4 | 8.6 | 31.7 | 40.7 | 20.2 | 29.6 | 32.8 |
| with 4-1-HH | | | | | | | | | | |
| Present invention | | | | | | | | | | |
| Diaper A | 47 | 41 | 45 | 0.2 | 7.9 | 28.3 | 36.4 | 19.4 | 27.7 | 32.7 |
| substituted | | | | | | | | | | |
| with 4-7-HE- | | | | | | | | | | |
| G-P (P side | | | | | | | | | | |
| up) | | | | | | | | | | |
| Diaper A | 48 | 49 | 71 | 0.2 | 5.3 | 28.2 | 33.7 | 19.8 | 29 | 33 |
| substituted | | | | | | | | | | |
| with 4-7-HE- | | | | | | | | | | |
| G-P (P side | | | | | | | | | | |
| down) | | | | | | | | | | |
| Diaper A | 53 | 43 | 64 | 0.1 | 4.2 | 26.4 | 30.7 | 20.9 | 29.7 | 33.3 |
| substituted | | | | | | | | | | |
| with 4-7-HE- | | | | | | | | | | |
| G-PP (PP | | | | | | | | | | |
| side up) | | | | | | | | | | |
| Diaper A | 51 | 39 | 42 | 0.1 | 7.5 | 30 | 37.6 | 20.8 | 31 | 32.7 |
| substituted | | | | | | | | | | |
| with 4-7-HE- | | | | | | | | | | |
| G-PP (PP | | | | | | | | | | |
| side down) | | | | | | | | | | |
| Diaper A | 45 | 33 | 38 | 0.1 | 4.2 | 23.7 | 28 | 17.7 | 27.8 | 32.7 |
| substituted | | | | | | | | | | |
| with 4-7-HE- | | | | | | | | | | |
| P (P side up) | | | | | | | | | | |
| Diaper A | 50 | 50 | 54 | 0.2 | 4.1 | 28.2 | 32.5 | 21.1 | 29.3 | 32.9 |
| substituted | | | | | | | | | | |
| with 4-7-HE- | | | | | | | | | | |
| P (P side | | | | | | | | | | |
| down) | | | | | | | | | | |
| Diaper A | 49 | 43 | 58 | 0.1 | 8 | 30.9 | 39 | 20.8 | 28.3 | 32.7 |
| substituted | | | | | | | | | | |
| with 4-7-HE- | | | | | | | | | | |
| PP (PP side | | | | | | | | | | |
| up) | | | | | | | | | | |
| Diaper A | 49 | 40 | 50 | 0.1 | 5.4 | 27.9 | 33.4 | 19.3 | 26.8 | 31.7 |
| substituted | | | | | | | | | | |
| with 4-7-HE- | | | | | | | | | | |
| PP (PP side | | | | | | | | | | |
| down) | | | | | | | | | | |

The same testes were done for another commercial diaper (B). This diaper has 6.7 gram of SAP and 3.7 gram of fluff. The diaper B used for this test is constructed as follows (from top): nonwoven topsheet, nonwoven acquisition (24 cm×7 cm) at 63 g/m2 basis weight, crosslinked fiber acquisition/distribution layer (3.93 gram at 229 g/m2), nonwoven, absorbent core (8.3 gram SAP and 11.2 gram of fluff), nonwoven, polymer nonwoven laminated backsheet. The various lyocell nonwoven composite with curly fiber layers were cut to the same size as the diaper B acquisition layer and then inserted into the diaper to replace both nonwoven acquisition and crosslinked fiber acquisition/distribution layer (two layers at a total basis weight of about 290 g/m2 was removed)

TABLE 7
Modified lyocell nonwoven for diaper testing

ADL layer properties

| Sample | BW total | Caliper | Weight | Density |
|---|---|---|---|---|
| Comparative 1 | | | | |
| Diaper B as is | 280 | 4.63 | 4.7 | 0.061 |
| Diaper B reconstructed | 280 | 4.63 | 4.7 | 0.061 |
| Comparative 2 | | | | |
| Diaper B | 78 | 0.68 | 1.31 | 0.115 |
| substituted with 4-1-NO | | | | |
| Present invention | | | | |
| Diaper B | 83 | 0.8 | 1.4 | 0.109 |
| substituted with 4-7-HE-P | | | | |

| | Core properties | | | | | | | | | |
|---|---|---|---|---|---|---|---|---|---|---|
| | Acquisition | | | rewet | | | | wicking distance | | |
| | time seconds | | | grams | | | total | cm | | |
| | doses | | | doses | | | rewet | doses | | |
| Sample | 1 | 2 | 3 | 1 | 2 | 3 | grams | 1 | 2 | 3 |
| Comparative 1 | | | | | | | | | | |
| Diaper B | 32 | 34 | 42 | 0.1 | 24.2 | 40.3 | 64.5 | 19.3 | 23.6 | 28.3 |
| as is | | | | | | | | | | |
| Diaper B | 28 | 30 | 36 | 0.1 | 22.2 | 40.7 | 63 | 19.1 | 23.3 | 27.2 |
| reconstructed | | | | | | | | | | |
| Comparative 2 | | | | | | | | | | |
| Diaper B | 95 | 93 | 133 | 0.6 | 20.1 | 38.5 | 59.2 | 21 | 26.2 | 31 |
| substituted | | | | | | | | | | |
| with 4-1-NO | | | | | | | | | | |
| Present invention | | | | | | | | | | |
| Diaper B | 80 | 70 | 112 | 0.2 | 20.4 | 38.4 | 59 | 23.5 | 27 | 32 |
| substituted | | | | | | | | | | |
| with 4-7-HE-P | | | | | | | | | | |

Meltblown lyocell nonwoven/airlaid Peach, or meltblown lyocell nonwoven/spunbonded polypropylene (PP) composites can be used for ADL in diaper. It is better than one layer meltblown lyocell nonwoven. The new composite used had lower total basis weight than both controls. The new core with the composites had similar total rewet performance as control diapers (diapers A and B). Diaper with Lyocell or Pulp cellulose in ADL will be more biodegradable than control diaper A since less synthetic products from petroleum was used in the diaper (A).

1. A composite product comprising a web of either airlaid fluff pulp or synthetic material overlaying and fastened to a web of hygroscopic regenerated cellulosic material wherein the regenerated cellulosic material has filament diameters in the range of 1 to 30 microns and wherein the basis weight of each of the webs is from 5 to 300 g/M².

2. The composite product of claim 1 wherein the regenerated cellulosic material is lyocell.

3. The composite product of claim 1 wherein the regenerated cellulosic material is viscose.

4. The composite product of claim 1 wherein the regenerated cellulosic material is woven or knit.

5. The composite product of claim 1 wherein the regenerated cellulosic material is nonwoven.

6. The composite product of claim 1 wherein the regenerated cellulosic material has an MD tensile strength of 200 to 2000 N/m

7. The composite product of claim 1 wherein the synthetic is selected from polypropylene, polyethylene, PET or combinations thereof.

8. The composite product of claim 1 wherein the product is embossed, thermobonded, needlepunched, or spunlaced.

9. The composite product of claim 1 wherein the basis weights of two webs different.

10. The composite product of claim 1 wherein the basis weights of two webs the same.

11. The composite product of claim 1 wherein the product has two surfaces and the wet coefficient of friction of each of the surfaces are different.

12. The composite product of claim 1 further comprising a second web of regenerated cellulosic material overlaying and fastened to the web of either airlaid fluff pulp or synthetic material on the side of opposite the first web of regenerated cellulosic material wherein the second web of regenerated cellulosic material has filament diameters in the range of 1 to 30 microns and wherein the basis weight of the second web of regenerated cellulosic material is from 5 to 300 g/m².

13. The composite product of claim 12 wherein the regenerated cellulosic material is lyocell.

14. The composite product of claim 12 wherein the regenerated cellulosic material is viscose.

15. The composite product of claim 12 wherein the regenerated cellulosic material is woven or knit

16. The composite product of claim 12 wherein the regenerated cellulosic material is nonwoven.

17. The composite product of claim 12 wherein the composite material has an MD tensile strength of 200 to 2000 N/m

18. The composite product of claim 12 wherein the synthetic is selected from polypropylene, polyethylene, PET or combinations thereof.

19. The composite product of claim 12 wherein the product is embossed or thermobonded or needlepunched or spunlaced.
